(19) United States
(12) Patent Application Publication
(10) Pub. No.: US 2022/0019484 A1
(43) Pub. Date: Jan. 20, 2022

(54) AUXILIARY RESOURCE EXCHANGE PLATFORM FOR POOLING RESOURCES USING A REAL TIME EXCHANGE NETWORK

(71) Applicant: BANK OF AMERICA CORPORATION, Charlotte, NC (US)

(72) Inventors: Justin Riley duPont, Charlotte, NC (US); Charles Jason Burrell, Middleburg, FL (US); Tony England, Tega Cay, SC (US); Michael Robert Hasslinger, Huntersville, NC (US); Christina Ann Lillie, Ann Arbor, MI (US); John Allen Sellers, Kennett Square, PA (US)

(73) Assignee: BANK OF AMERICA CORPORATION, Charlotte, NC (US)

(21) Appl. No.: 16/933,685

(22) Filed: Jul. 20, 2020

(51) Int. Cl. G06F 9/50; H04L 29/08

(52) U.S. Cl. CPC G06F 9/5083; H04L 67/32; G06F 9/5027

(57) ABSTRACT

Real-time interaction processing may allow for the exchange of resources and/or supplemental resources. The flexibility of the real-time resource exchange network allows supplemental resources to be transferred between resources pools of a single entity or between resource pools of different entities, either within a single organization or located at different organizations. The real-time interaction processing further allows for the creation and use of a collective resource pool to which multiple entities are allowed to contribute resources and/or supplemental resources. Each of the entities contributing resources or supplemental resources to the collective resource pool have transparency into the entities contributing to the collective resource pool, the supplemental resources and/or other resources contributed, and confirmation that the actual interaction for which the collective resource pool is being utilized was completed.

### FIELD

The present disclosure relates to utilizing a real-time exchange network for exchanging resources, and more particularly, for exchanging supplemental resources into a collective resource pool and entering an interaction using the collective resource pool.

### BACKGROUND

Traditional resource exchanges require transferring resources over traditional processing channels. Moreover, the development of improved rapid interaction completion systems provides the ability to replace the use of many of the traditional processing channels. There exists a need for providing a more efficient exchange of resources within the rapid interaction completion system.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method and computer program product for a real-time resource exchange that allows for the exchange of supplemental resources. Real-time interaction processing is provided by establishing an operable communication linkage between entities and/or organizations, including a real-time time resource exchange organization. The real-time interaction processing may include the use of supplemental resources that cannot be transferred over traditional processing rails. However, by using the flexibility of the real-time resource exchange network, the supplemental resources may be transferred between resources pools of a single entity or between resource pools of different entities, either within a single organization or located at different organizations. The type of supplemental resources and number of supplemental resources may be converted based on the types of resource pools from which and to which the supplemental resources are being transferred. The real-time interaction processing may further allow for the creation and use of a collective resource pool to which multiple entities are allowed to contribute the same type of supplemental resources, different types of supplemental resources, and/or resources from resource pools with the same organization or with different organizations. The supplemental resources and/or resources may be converted based on the type of the collective resource pool. Each of the entities contributing supplemental resources or other resources to the collective resource pool may have transparency into the entities contributing to the collective resource pool, the supplemental resources and/or other resources contributed to each resource pool, and confirmation that the actual interaction for which the collective resource pool is being utilized was completed.

Embodiments of invention comprise systems, computer implemented methods, and/or computer program products for making resource exchanges over a real-time exchange network. The invention comprises receiving a request from a first entity to utilize a collective resource pool, and receiving supplemental resources for the collective resource pool from a first entity resource pool of the first entity and one or more additional entity resource pools from one or more additional entities. The invention comprises receiving a request to enter into an interaction with a third-party entity, and transferring the supplemental resources from the collective resource pool to a third-party resource pool. The invention further comprises providing interaction information regarding completion of the interaction with the third-party to the first entity and the one or more additional entities.

In further accord with embodiments, the invention further comprises creating the collective resource pool for the interaction with the third-party, and providing collective resource pool information to the first entity and the one or more additional entities.

In other embodiments of the invention, receiving the request from the first entity to utilize the collective resource pool comprises utilizing a previously created resource pool and creating a new interaction within the collective resource pool for the interaction with the third-party.

In still other embodiments, the invention further comprises receiving an indication from the first entity to invite the one or more additional entities to provide the supplemental resources to the collective resource pool.

In yet other embodiments, the invention further comprises providing an indicator of the collective resource pool, the interaction, and the third-party to the one or more additional entities.

In other embodiments, the invention further comprises settling the interaction between the collective resource pool, the third-party resource pool, and the first entity resource pool and the one or more additional entity resource pools.

In further accord with embodiments of the invention, the request to enter into the interaction is made by the first entity through a first entity computer system.

In other embodiments of the invention, receiving the request from the first entity to utilize the collective resource pool further comprises receiving a proposed interaction with the third-party for the collective resource pool.

In still other embodiments of the invention, the supplemental resources are converted into resources before being transferred from the collective resource pool to the third-party resource pool.

In yet other embodiments of the invention, the supplemental resources are converted from the resources back to the supplemental resources within the third-party resource pool.

In other embodiments of the invention, the supplemental resources are transferred directly between the collective resource pool and the third-party resource pool without being converted to resources.

In further accord with embodiments of the invention, an original amount of the supplemental resources are transformed to an updated amount of the supplemental resources during the transfer.

In other embodiments of the invention, the supplemental resources are transformed from an original supplemental resource type to an updated supplemental resource type during the transfer.

In still other embodiments of the invention, the supplemental resources received from the first entity or the one or more additional entities are transformed from an original supplemental resource type or an original amount to an updated supplemental resource type or an updated amount before transferred to the collective resource pool.

In yet other embodiments of the invention, the supplemental resources are transferred from the collective resource pool to the third-party resource pool when the supplemental resources within the collective resource pool reach a trigger amount.

In other embodiments of the invention, the supplemental resources are transferred from the collective resource pool to the third-party resource pool when a trigger time period is met.

In further accord with embodiments of the invention, the transfer of the supplemental resources occurs through the real-time exchange network directly between the collective resource pool and the third-party resource pool without using traditional processing rails.

In other embodiments, the invention further comprises providing a notification to the one or more additional entities when an entity transfers the supplemental resources to the collective resource pool, wherein the notification comprises at least the entity an amount of the supplemental resources.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a real-time interaction system environment, in accordance with some embodiments of the present disclosure.

FIG. 2 provides a block diagram of a real-time interaction flow, in accordance with some embodiments of the present disclosure.

FIG. 3 provides a process flow for processing the exchange of supplemental resources in real-time resource exchange networks, in accordance with some embodiments of the present disclosure.

FIG. 4 provides a process flow for processing the exchange of supplemental resources into a collective resource pool for use in real-time resource exchange networks, in accordance with some embodiments of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

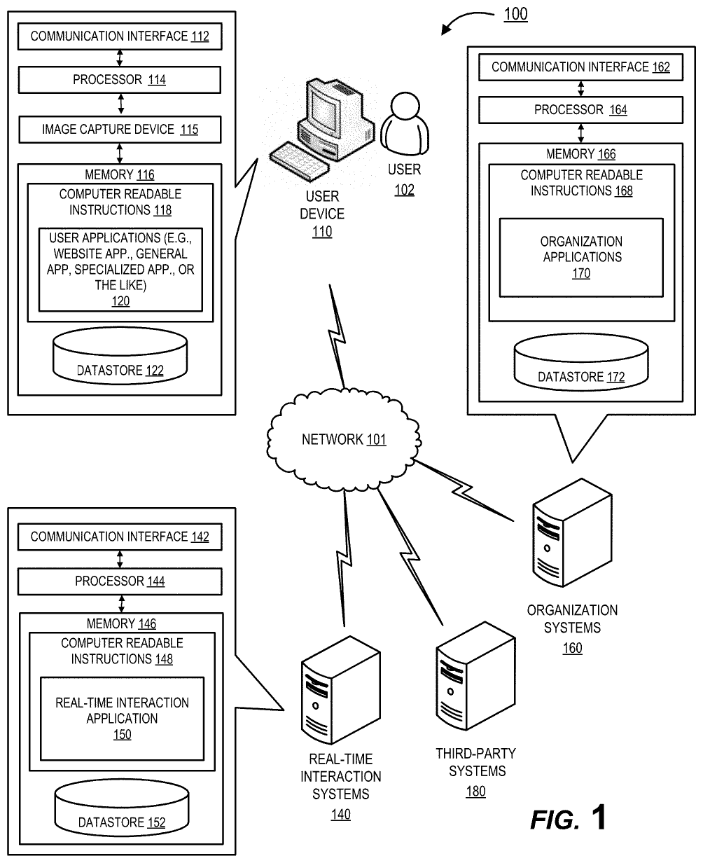

FIG. 1 provides a system that includes specialized systems and devices communicably linked across a distributive network of nodes required to perform the functions of implementing the real-time interaction processing system as described herein. FIG. 1 provides a real-time interaction processing network 100, in accordance with some embodiments of the present disclosure. As illustrated in FIG. 1, the real-time interaction system 140 (e.g., operated by one or more of the organizations or a third party organization, such as a resource exchange organization) is operatively coupled, via a network 101 to the user device 110, the one or more organization systems 160, and/or the one or more third-party systems 180. In this way, the real-time interaction system 140 can send information to, and receive information from, the user device 110, the organization systems 160, and/or the third-party systems 180. FIG. 1 illustrates only one example of some embodiments of the real-time interaction processing network 100, and it will be appreciated that in other embodiments one or more of the systems, devices, or servers may be combined into a single system, device, or server, or be made up of multiple systems, devices, or servers.

In accordance with embodiments of the invention, the term “entity” may be used instead of “user” or “party” (e.g., third party). As such, it should be understood that while the embodiments described herein discuss interactions between users, parties, and/or each other, it should be understood that the interactions may be described as occurring between entities (e.g., a first entity, a second entity, or the like). Consequently, the term “entity” may include any user 102 acting on his/her own behalf, any party (e.g., business, company, third-party or the like) acing on its own behalf, or any user 102 acting on behalf of any party. An “organization” may refer to a business, company, or the like that maintains or operates the system or a portion thereof, including allowing for the exchange of resources between the various entities described herein.

The network 101 may be a system specific distributive network receiving and distributing specific network feeds and identifying specific network associated triggers. The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network 101.

In some embodiments, the entity (e.g., a user 102) utilizes an entity device (e.g., a user device 110), otherwise described as a user computer system 110, to implement the real-time interaction processing over the network 101, such as by initiating, implementing, settling, and/or monitoring an interaction that involves a resource exchange and/or a supplemental resource exchange. In some embodiments the entity (e.g., a user 102, party, or the like) is completing an interaction leveraging a real-time interaction system 140 with another resource pool of the same entity or with another entity (e.g., another user 102, another party, or the like).

In some embodiments, the user 102 has a user device 110, such as a mobile device (e.g., a mobile phone, smart phone, tablet, or the like) that may interact with a device 110 of another user 102 and/or the systems and devices described herein to allow for an interaction, in which resources and/or supplemental resources are exchanged. In some embodiments, the user 102 may be a computing device user, a phone user, a mobile device application user, a customer (e.g., a resource pool holder or a person who has a resource pool, or the like), a system operator, database manager, a support technician, and/or employee of an entity. In some embodiments, identities of an individual user may include online handles, usernames, identification numbers (e.g., Internet protocol (IP) addresses), e-mail addresses, phone numbers, aliases, family names, maiden names, nicknames, or the like.

As used herein, the term “user device” or “user computer system” may refer to any device that employs a processor and memory and can perform computing functions, such as a personal computer or a mobile device, wherein a mobile device is any mobile communication device, such as a cellular telecommunications device (e.g., a cell phone or mobile phone), personal digital assistant (PDA), a mobile Internet accessing device, smartphone, or other mobile device. Other types of mobile devices may include pagers, wearable devices, mobile televisions, gaming devices, laptop computers, cameras, video recorders, audio/video player, radio, global positioning system (GPS) devices, or any combination of the aforementioned. In some embodiments, a device may refer to any computer system, platform, server, database, networked device, or the like. The device may be used by the user to access the system directly or through an application, online portal, internet browser, virtual private network, or other connection channel. The device may be a computer device within a network of connected computer devices that share one or more network storage locations.

It is understood that the servers, systems, and devices described herein illustrate some embodiments of the present disclosure. It is further understood that one or more of the servers, systems, and devices can be combined in other embodiments and still function in the same or similar way as the embodiments described herein.

As illustrated in FIG. 1, the user device 110 may generally include a processing device, processing component, or processor 114 communicably coupled to devices such as, a memory device 116, user output devices (for example, a user display device, or a speaker), user input devices (such as a microphone, keypad, touchpad, touch screen, and the like), a communication device or network interface device 112, a power source, a clock or other timer, an image capture device 115 such as a camera, video recorder, or the like, a positioning system device, such as a geo-positioning system device like a GPS device or the like and the like. The processing device 114 may further include a central processing unit, input/output (I/O) port controllers, a graphics controller or GPU, a serial bus controller and a memory and local bus controller.

As used herein, the term “processing device”, “processing component” or “processor” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

A processor may be configured to use a network interface to communicate with one or more other devices on the network 101. In this regard, the network interface may include an antenna operatively coupled to a transmitter and a receiver (together a “transceiver”). The processor may be configured to provide signals to and receive signals from the transmitter and receiver, respectively. The signals may include signaling information in accordance with the air interface standard of the applicable cellular system of the wireless telephone network that may be part of the network 101. In this regard, the systems may be configured to operate with one or more air interface standards, communication protocols, modulation types, and access types. By way of illustration, the components may be configured to operate in accordance with any of a number of first, second, third, fourth, fifth-generation communication protocols, and/or the like. For example, the computing systems may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, or the like. The components may also be configured to operate in accordance with non-cellular communication mechanisms, such as via a wireless local area network (WLAN) or other communication/data networks.

The communication interface or network interface may also include an application interface in order to allow an entity (e.g., user, merchant, organization, or the like) to execute some or all of the processing described herein. The application interface may have access to the hardware (e.g., the transceiver, and software previously described with respect to the network interface). Furthermore, the application interface may have the ability to connect to and communicate with an external data storage on a separate system within the network 101.

The communication interface or network interface may include an interface for a wireless transceiver, modem, server, electrical connection, electrical circuit, or other component for communicating with other components on the network 101. The one or more communication interfaces may further include an interface that accepts one or more network interface cards, ports for connection of network components, Universal Serial Bus (USB) connectors, or the like. The communication interfaces may have an interface that includes the user output devices and/or input devices. The input and/or output devices may include a display (e.g., a liquid crystal display (LCD) or the like) and a speaker or other audio device, which are operatively coupled to the processor. The input and/or output devices, which may allow the devices to receive data from or send data to a user, may further include any of a number of devices allowing the devices to receive data from a user, such as a keypad, keyboard, touch-screen, touchpad, microphone, mouse, joystick, other pointer device, button, soft key, and/or other input and/or output device(s).

The processor 114 may include functionality to operate one or more software programs or applications, which may be stored in the memory 116. For example, the processor 114 may be capable of operating applications such as the user application 120. The user application 120 may be configured to allow the user device 110 to transmit and receive data and instructions from the other devices and systems. The user device 110 comprises computer-readable instructions 118 and data storage 122 stored in the memory device 116, which in some embodiments include the computer-readable instructions 118 of a user application 120. In some embodiments, the user application 120 allows a user 102 to access and/or interact with content provided from an entity or an account maintained by an entity. In some embodiments, the user application 120 further includes features for accessing a real-time interaction exchange platform to initiate, complete, and/or view the life cycle of an interaction in real-time. In this way, the user 102 may have a holistic view of available resources and/or supplemental resources for exchange over the real-time resource exchange network 200 instead of being reliant on the uncertainty of traditional, end-of-period settlement methods and processing rails (e.g., traditional clearing houses and card payment rails). The user application 120 may also allow the user to manage and view detailed information related to a plurality of past and/or pending interactions that include resource exchanges.

The user device 110 may also include a memory buffer, cache memory or temporary memory device operatively coupled to the processor 114. Typically, one or more applications 120 are loaded into the temporary memory during use. As used herein, memory may include any computer readable medium configured to store data, code, or other information. The memory 116 may include volatile memory, such as volatile Random-Access Memory (RAM) including a cache area for the temporary storage of data. The memory 116 may also include non-volatile memory, which can be embedded and/or may be removable. The non-volatile memory may additionally or alternatively include an electrically erasable programmable read-only memory (EEPROM), flash memory or the like.

FIG. 1 further provides a block diagram of the real-time interaction system 140, in accordance with embodiments of the invention. The real-time interaction system 140 generally comprises a communication interface 142, a processor 144, and a memory 146. The processor 144 is operatively coupled to the communication interface 142 and the memory 146. The processor 144 uses the communication interface 142 to communicate with the network 101 and other devices on the network 101, such as, but not limited to the user devices 110, the organization systems 160, and/or the third-party systems 180. As such, the communication interface 142 generally comprises a modem, server, transceiver, or other device for communicating with other devices on the network 101.

The real-time interaction system 140 comprises computer-readable instructions 148 stored in the memory 146, which in some embodiments include the computer-readable instructions 148 of a real-time interaction application 150. In some embodiments, the memory 146 includes data storage 152 for storing data related to the system environment, but not limited to data created and/or used by the real-time interaction application 150. In some embodiments, the datastore or data storage 152 of the real-time interaction system may store a record of one or more interactions (e.g., transactions) and/or electronic instruments.

Embodiments of the real-time interaction system 140 may include multiple systems, servers, computers or the like maintained by one or many organizations. FIG. 1 merely illustrates one of those systems that, typically, interacts with many other similar systems, such as the user devices 110, the organization systems 160, and/or third-party systems 180, to complete and settle interactions over real-time resource exchange networks 200. In some embodiments, the real-time interaction system 140 may be part of an organization system 160, third-party system 180, or vice versa. The real-time interaction system 140 may communicate with the user devices 110, organization systems 160, and/or third-party systems 180 via a secure connection generated for secure encrypted communications between the systems.

In some embodiments of the real-time interaction system 140, the memory 146 stores a real-time interaction application 150. In some embodiments of the present disclosure, the real-time interaction application 150 may associate with applications having computer-executable program code that instructs the processor 144 to operate the network communication interface 142 to perform certain communication functions described herein. In some embodiments, the computer-executable program code of an application associated with the real-time interaction application 150 may also instruct the processor 144 to perform certain logic, data processing, and data storing functions of the application.

The processor 144 is configured to use the communication interface 142 to gather data, such as data corresponding to interactions from various data sources such as the user devices 110, organization systems 160, and/or third-party systems 180. The processor 144 stores the data that it receives in the memory 146. The memory 146 may further comprise stored user account information (e.g., account number, routing number, user identifying information, or the like).

FIG. 1 further provides a block diagram of one or more organization systems 160, in accordance with embodiments of the invention. In some embodiments, the organization systems 160 may refer to the systems of organizations that hold resources for the entities and/or for other parties, facilitates interactions between the entities and/or organizations, or the like. The organization systems 160 generally comprise a communication interface 162, a processor 164, and a memory 166. The processor 164 is operatively coupled to the communication interface 162 and the memory 166. The processor 164 uses the communication interface 162 to communicate with the network 101 and other devices on the network 101, such as, but not limited to the user devices 110, the real-time interaction systems 140, and/or the third-party systems 180. As such, the communication interface 162 generally comprises a modem, server, transceiver, or other device for communicating with other devices on the network 101.

The organization systems 160 further comprise computer-readable instructions 168 stored in the memory 166, which in some embodiments include the computer-readable instructions 168 of an organization application 170. In some embodiments, the memory device 166 includes data storage 172 for storing data related to the real-time interaction processing network 100, but not limited to data created and/or used by the organization systems 160, the user devices 110, or the real-time interaction systems 140.

Embodiments of the organization systems 160 may include multiple systems, servers, computers or the like maintained by one or many organizations. In some embodiments, the real-time interaction systems 140 may or may not be distinct from the organization systems 160. The organization systems 160 may communicate with the real-time interaction systems 140 via secure connections generated for secure encrypted communications between the systems.

In some embodiments of the organization systems 160, the memory 166 stores an organization application 170. In some embodiments, the memory 166 stores data including, but not limited to, at least portions of interaction records comprising a record of one or more real-time interactions. In some embodiment of the disclosure, the organization application 170 may associate with applications having computer-executable program code that instructs the processor 164 to operate the network interface 162 to perform certain communication functions described herein. In some embodiments, the computer-executable program code of an application 170 may also instruct the processor 164 to perform certain logic, data processing, and data storing functions of the application.

The processor 164 is configured to use the communication interface 162 to gather data, such as data corresponding to interactions, such as real-time resource exchange interactions. In some embodiments, the processor 164 may be configured to identify real-time resource exchange interactions and enter into the real-time interactions, complete the real-time interactions, and/or monitor the real-time interactions, and store the forgoing (e.g., in data store 172, or the like). The organization systems 160 may maintain a detailed record of a series of interactions that are updated in real-time based the real-time interactions taking place. In this way, the organization systems 160 (e.g., individual organizations, resource exchange organization, or the like) may track interactions and resource flows accurately in real-time instead of relying on traditional end-of-period, batch-processing clearing and settlement methods.

The one or more third party systems 180 may comprise the systems that a third party (e.g., a product provider) uses to enter into interactions with users 102. For example, the third-party may be a merchant that provides a product (e.g., goods or services) to a user 102 during an interaction, and collects resources from the user 102 (e.g., or an entity or organization of the user 102) through the one or more organization systems 160. It should be understood that both the user 102 and the product provider party may have resource pools with one or more organizations in order to allow for a resource transfer associated with the interaction.

As such, it should be understood, and as will be described herein in further detail, the interaction may occur between resource pools of a single user 102, between two users 102 using the user devices 110 on behalf of themselves, between a user 102 and a third-party (directly with a third-party or with another user operating on behalf of the third-party), and/or between two parties (directly with each other). As such, any entity may interact with itself or may interact with any other entity.

As used herein, a “real-time interaction” refers to a resource exchange (or transfer) between users and/or entities participating in and leveraging a settlement network operating in real-time (e.g., twenty-four hours a day, seven days a week), wherein settlement of the interaction occurs at or very close in time to the time of the interaction (i.e., real-time). A real-time interaction may include a resource exchange, wherein a real-time interaction system 140 enables participants to initiate credit transfers, receive settlement for credit transfers, and make available to a receiving participant resources (e.g., funds) and/or supplemental resources (e.g., rewards points, travel points, airline miles, or other like replacement resources) associated with the credit transfers in real-time, wherein the credit transfer may be final and irrevocable. Real-time interactions and resource exchanges provide marked improvements over traditional interaction clearing and transfer settlement methods (e.g., automated clearing house (ACH), wire, card processing rails, or the like) which can require several hours, days, or longer to receive, process, authenticate an interaction and resource exchange (i.e., clearing), and make funds available to the receiving participant which may, in total, require several back-and-forth communications between involved organizations (e.g., financial institutions). In some cases, conventional settlement methods may not be executed until the end of the business day (EOB), wherein resource exchanges are settled in batches between organizations.

Real-time interactions reduce settlement time by providing pre-authentication or authentication at the time of a requested interaction in order to enable instantaneous or near-instantaneous (i.e., real-time) resource exchange and settlement between organizations at the time of the interaction, wherein resources and/or supplemental resources may be made immediately available to a receiving entity (i.e., payee) following completion of the interaction. Examples of real-time interactions include business to business interactions (e.g., supplier exchanges), business to consumer interactions (e.g., legal settlements, insurance claims, employee wages), consumer to business interactions (e.g., bill pay, hospital co-pay, payment at point-of-sale), and peer to peer (P2P) interactions (e.g., repayment or remittance between friends and family). In a specific example, a real-time interaction may be used for payment of a utility bill on the due date of the bill to ensure payment is received on-time and accruement of additional funds due to late payment is avoided. In some embodiments, a negotiable instrument (e.g., check, or the like) may be used to exchange resources; however, a real-time interaction may be used to make the resource exchange using the negotiable instrument. In another example, real-time interactions may be especially beneficial for small entities and users (e.g., small merchants/businesses) that may have a heavier reliance on short-term resources and may not prefer to wait days for resource settlements.

Real-time interactions not only provide settlement immediacy, but also provide assurance, misappropriation reduction, and bank-grade security to resource exchanges due to the inherent nature of the resource exchange and user authentication infrastructure. Further, real-time interactions may reduce payment processing costs due to the simplified nature of required communication when compared to conventional settlement methods. In some embodiments, real-time interaction systems 140 further include information and conversation tools that financial institutions may utilize to enhance a settlement experience for the entities. Furthermore, the real-time interactions may allow for the transfer of one or more different types of resources, such as supplemental resources (e.g., reward points, airline miles, travel rewards, or other resource equivalents) that cannot be directly transferred over through traditional rails.

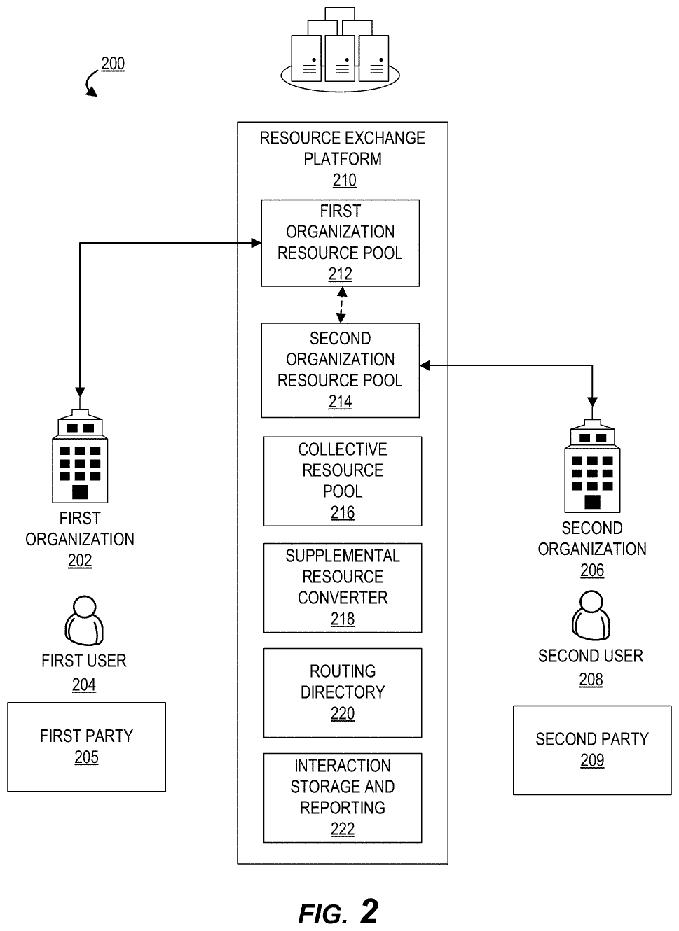

A system leveraging a real-time resource exchange network 200 allows for an interaction with a resource exchange to be completed between participating entities via an intermediary clearing house acting in the role of a neutral party. Organization resource pools (e.g., financial institution resource pools) are held at the resource exchange organization (e.g., clearing house) and administered by both the organizations and the resource exchange organization. In this way, the resource exchange organization is able to exchange resources between organization resource pools on behalf of the organizations in order to settle interactions between entities affiliated with the organizations (e.g., customers of the organizations). A real-time interaction network flow is discussed in further detail with respect to FIG. 2.

FIG. 2 illustrates a block diagram of a real-time resource exchange network 200, in accordance with some embodiments of the invention. In the illustrated environment, a first user 204 (e.g., acting on his/her own benefit, for the benefit of a first party—a first merchant, or the like) is associated with (e.g., a customer of) a first organization 202 (e.g., first financial institution, or the like) and a second user 208 (e.g., acting on his/her own benefit, for the benefit of a second party—a second merchant, or the like) is associated (e.g., a customer of) a second organization 206 (e.g., a second financial institution). A resource exchange organization may utilize a resource exchange platform 210 (e.g., a real-time interaction clearing house, or the like) to facilitate (e.g., hold, service, or the like) a first resource pool 212 (e.g., first account, or the like) associated with the first organization 202 (e.g., first financial institution, or the like) and a second resource pool 214 (e.g., second account, or the like) associated with the second organization 206 (e.g., second financial institution, or the like). The first resource pool 212 and the second resource pool 214 are accessible by each associated organization (e.g., the first organization 202 and the second organization 206, respectively) and the resource exchange organization, which acts as a trusted intermediary during settlement between the organizations affiliated with each entity (e.g., each user 204, 208, and/or party 205, 209). Resources (e.g., funds, or the like) and/or supplemental resources (e.g., rewards points, or other like resource equivalents) may be transferred by each organization (e.g., first organization 202, second organization 206, or the like) to and from their associated resource pools 212, 214 with the resource exchange organization. Exchanges between the first resource pool 212 and the second resource pool 214 are administered by the resource exchange organization pending authentication and authorization by participating entities of each resource exchange. It should be understood that since the resource exchange organization maintains resource pools for each organization, the transfer of resources may be made in real-time as described herein (e.g., within 10, 5, or the like seconds). The amount of resources and/or supplemental resources within the resource pools 212, 214 of the organizations 202, 206 may be estimated based on the estimated number of interactions and estimated amounts thereof that each organization 202, 206 typically enters on behalf of its entities (e.g., customers).

In some embodiments it should be understood that the first organization 202 and the second organization 206 may be the same organization such that the interaction occurs between the first user 204 and the second user 208 within the same organization. Additionally, or alternatively, the first user 204 and the second user 208 may be same user, such that the interaction may occur between different resource pools of the first user 204 within the same organization or between different organizations (e.g., the first organization 202 and the second organization 206). Moreover, in some embodiments the resource exchange organization may be the same as the first organization 202 and/or the second organization 206, such that the organization that is responsible for the first user 204 or the second user 208 is also responsible for the resource exchange platform 210.

Furthermore, while the resources being transferred in association with an interaction may be funds, as will be described herein, supplemental resources (e.g., rewards, such as rewards points that may be used in place of traditional funds) may be included in the interaction or may be the sole form of resources for the interaction. As will be described herein in further detail, the supplemental resources may transferred between resource pools over real-time resource exchange network 200, such as between resource pools of a user within a single organization, between resource pools of a user with different organizations, between resource pools of two users at the same organization, and/or between resource pools of two users at different organizations.

In some embodiments, the supplemental resources may be attached to resources used from resource pools (e.g., checking accounts, savings accounts, debit accounts, or other like traditional accounts); however, in some embodiments the resource pools may be supplemental resource pools (e.g., reward accounts, or the like) that are used specifically for supplemental resources that can be used in the same or similar ways for an interaction as traditional resources are typically used (e.g., transferring funds).

Moreover, in some embodiments of the invention the resource exchange organization may provide the ability for a first entity to create a collective resource pool 216 (e.g., a collective supplemental resource pool) that may be used to pool resources and/or supplemental resources from multiple entities (e.g., multiple users, or the like) in order to enter into interactions with a third-party entity, as will be described in further detail herein.

Furthermore, the resource exchange network may include a supplemental resource conversion module 218, a routing directory module 220, and/or an interaction storage and reporting module 222. The supplemental resource conversion module 218 may store conversions for each type of resource pool and/or organization that utilizes the resource exchange platform 210. For example, the supplemental resources for a first resource pool at a first organization 202 may utilize rewards points that are worth one cent per point. Alternatively, the second resource pool at the second organization may utilize rewards points that are worth one dollar per point. As such, when supplemental resources (e.g., rewards points, or the like) are transferred between the first resource pool and the second resource pool the supplemental resources may be required to be converted to the supplemental resource type and scale used by the destination resource pool. As such, the supplemental resource conversation module 218 may include stored supplemental conversions (e.g., reward points, airline miles, travel points, or the like conversions) between each of the resource pools and/or organizations in order to allow the resource exchange platform 210 to quickly verify how the supplemental resources may be scaled or the supplemental resource type may change should different resource pools and/or organizations utilize different supplemental resource programs. Each organization may upload the resource equivalent (e.g., fund equivalent, such as cash equivalent) of its supplemental resources in order to provide a standard in which to value the supplemental resources of each supplemental resource program. In some embodiments, the supplemental resources are not converted into resources (e.g., a cash equivalent), but a value of the resources (e.g., cash equivalent) may be utilized in order to determine how to convert and/or scale the supplemental resources between resource pools. Moreover, each organization may update the resource equivalent if and when a supplemental resource program changes. Additionally, and/or alternatively, while the supplemental resource converter module 218 may store resource equivalents, each individual organization may adjust the conversion information on an interaction-by-interaction basis. For example, in order to entice an entity (e.g., a first entity) to transfer supplemental resources to another resource pool or to enter into an interaction with a second entity using supplemental resources, an organization may provide a different resource equivalent for a particular interaction a supplemental resource adjustment (e.g., a bonus, a multiplier, an add-on, or the like) for individual interactions.

The routing directory 220 may be utilized by the resource exchange platform 210, the resource exchange organization, the other organizations 202, 206, and/or third parties in order to determine where and how to rout the real-time resource exchange for each interaction. A real-time resource exchange interaction (e.g., message, or the like) may utilize one or more identifiers (e.g., token, QR Code, barcode, mobile number, e-mail address, or the like) that the resource exchange platform 210 may utilize by looking up the one or more identifiers in the routing directory 220 in order to determine to which resource pool (e.g., second resource pool 214), organization (e.g., second organization), and/or entity (e.g., second entity—second user 208 and/or second party 209) to which the resources and/or supplemental resources should be routed for the interaction. The resource directory 220 (e.g., one or more resource directories) may also be used to determine the processing, error codes, resource exchange treatments, or the like that may be used to process interactions and/or the associated resource exchanges.

In some embodiments, the resource exchange platform 210 may further utilize an interaction storage and reporting module 222. The interaction storage and reporting module 222 may store information regarding the interactions and resources and/or supplemental resources for each of the interactions of an organization (e.g., incoming and/or outgoing resource exchanges). Moreover, the interaction storage and reporting module 222 allows for reporting regarding the interactions of an organization. For example, the interaction storage and reporting module 222 may be used to send notifications to the organizations and/or entities related to the interactions that are entered into, in process, and/or completed, and interaction information related thereto.

As an illustrative example, the first user 204 and the second user 208 are participants of a real-time interaction, wherein the first user 204 (e.g., the payor) initiates a resource and/or supplemental resource transfer to the second user 208 (e.g., the payee). The first user 204 may initiate the exchange from the first financial institution 202, wherein the first user 204 provides authentication credentials to authenticate the identity of the first user 204 and to validate that a first user resource pool of the first user 204 held at the first financial institution 202 contains at least a required amount of available resources and/or supplemental resources to fulfill the resource exchange. While in some embodiments, the first user 204 may initiate the exchange from a physical, brick-and-mortar location of the first organization 202, in alternative embodiments described herein, the exchange may be initiated from other locations wherein the first user 204 is not required to be at a brick-and-mortar location (e.g., initiated via an electronic application, a website, or the like, such as through a user device 110).

The first user 204, as the sending participant (e.g., payor), may be required to authenticate his or her identity by providing credentials to the associated organization (e.g., first organization 202, resource exchange organization, or the like). For example, authentication information may include account numbers, routing numbers, PIN numbers, username and password, date of birth, social security number, or the like, or other authentication information as described herein. In some embodiments, authentication may comprise multi-factor or multi-step authentication in accordance with information security standards and requirements.

As such, as used herein “authentication credentials” is any information that can be used to identify a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device 110. This authentication information may be used to authenticate the identity of the user (e.g., determine that the authentication information is associated with the account) and determine that the user 102 has authority to access an account or system. The entity or organization may employ additional computer systems, such as authentication servers, to validate and certify resources and/or supplemental resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing device, or the like to access, write, delete, copy, or modify data within at least a portion of the system.

Returning to the illustrative example, upon initiating an interaction, the first user 204 becomes obligated to exchange the resources and/or supplemental resources for the interaction. As such, in some embodiments the interaction, and resource exchange thereof, cannot be canceled by the first user 204 following initiation and communication to an intermediary and/or a receiving participant of the interaction. The second user 208, as the receiving participant (e.g., the payee), receives communication to accept the resource exchange, in some embodiments following similar user authentication requirements made by the first user 204. Communication between participants for the interaction may be transmitted between the organizations 202, 206 via the resource exchange platform 210, which directs the resource exchange to the appropriate organizations 202, 206 associated with the participants (e.g., organizations, entities, or the like). The exchange of resources and/or supplemental resources occurs between the resource pools 212, 214 of the financial institutions 202, 206 on behalf of their respective users 204, 208, wherein the interaction may be settled immediately, concurrent with the resource exchange. As settlement occurs between the representative organizations (e.g., financial institutions, clearing house), debiting and crediting of individual user resource pools may be managed at each organization with their individual customer and through the organization resource pools at the resource exchange organizations 210. As the interaction is settled immediately, resources and/or supplemental resources may be made available for use in real-time, which may be immediate or near real-time.

It should be understood that real-time may be within minutes, seconds, (e.g., within 60, 40, 20, 15, 10, 5, 4, 3, 2, 1, or the like seconds), or the like.

It should be understood that while the illustrated embodiments of FIG. 2 depicts only first and second users 204, 206, organizations 202, 206, and resource pools 212, 214, other embodiments of a real-time interaction network may comprise a plurality of resource pools for a plurality of organizations (e.g., financial institutions), and/or for a plurality of entities. In some embodiments, the real-time resource exchange network 200 may further comprise more than one resource exchange organization or at least a plurality of resource exchange organizations (e.g., TCHs, the Federal Reserve, and the like), which cooperate within a real-time resource exchange network 200 to receive and process interaction requests as described herein. It should be understood that the organizations 202, 206 may include one or more community banks, regional banks, credit unions, corporate banks, direct connect financial institutions, or the like. When the organization is a “financial organization”, such as a “financial institution”, these terms may mean any organization that processes financial transactions (e.g., a transfer of funds or other monetary or financial resources) including, but not limited to, banks, credit unions, savings and loan associations, investment companies, stock brokerages, resource management firms, insurance companies and the like. In specific embodiments of the invention, use of the term “bank” is limited to a financial entity in which account-bearing customers conduct financial transactions, such as account deposits, withdrawals, transfers and the like.

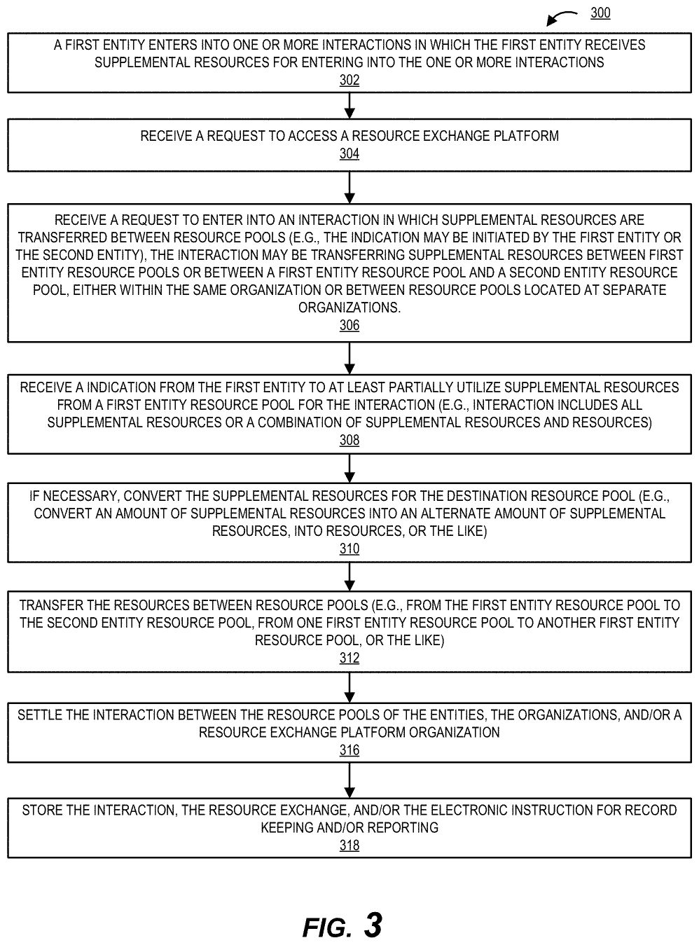

FIG. 3 illustrates a process flow for processing the exchange of supplemental resources over real-time resource exchange network 200 using a resource exchange platform 210. Block 302 of FIG. 3 illustrates that a first entity enters into one or more interactions in which the first entity receives supplemental resources (e.g., rewards points, or the like) for entering into the one or more interactions. For example, the interactions may include opening a resource pool (e.g., new checking, investment, retirement account, or the like), using services (e.g., wealth management, or the like) from an organization (e.g., a first financial institution, a second financial institution), purchasing products (e.g., goods or services) from a third-party (e.g., a merchant), or the like. Upon the occurrence of the one or more interactions the first entity may receive supplemental resources, such as rewards points, that the first entity may be able to utilize alone or in combination with other resources (e.g., electronic funds, or the like) to enter into additional interactions. The supplemental resources may be located within the first entity's resource pool (e.g., along with the other resources of the user), or may be located within a specific first entity supplemental resource pool, such as within a rewards account that is specific for holding the rewards points earned and/or received by the first entity.

Block 304 of FIG. 3 further illustrates that a request is received to access a resource exchange platform 210 in order to enter into an interaction (e.g., real-time interaction). For example, a first entity (e.g., first user, or the like) may access a real-time exchange platform 210 that may be operated by a resource exchange organization (e.g., independent organization, the first organization 202, the second organization 206, or the like), as previously discussed herein. The real-time exchange platform 210 may be accessed through a real-time resource exchange graphical user interface using a user application 120 on a user computer system 110.

FIG. 3 further illustrates in block 306 that a request is received to enter into an interaction to transfer resources between resource pools. It should be understood that the interaction may be between resource pools of the first entity at the same organization or at different organizations. The interaction may be between a first entity and a second entity having resource pools at the same organization or at different organizations. The indication of the interaction may be initiated by the first entity or the second entity. For example, the interaction may be a request to purchase a product (e.g., a first user purchasing a product from a third-party or another user) using supplemental resources; a request to transfer supplemental resources to another resource pool of the first entity (e.g., transferring rewards between accounts to cover a rewards purchase); a request to transfer supplemental resources to a resource pool of a second entity (e.g., gift, charity, or the like); a request to transfer supplemental resource to another organization to receive a benefit (e.g., transferring rewards points to receive additional rewards); and/or other like interactions.

Block 308 of FIG. 3 illustrates that an indication may be received to utilize supplemental resources at least partially for the interaction. In some embodiments a combination of resources (e.g., funds) and supplemental resources (e.g., rewards) may be utilized for the interaction. However, in some embodiments, the interaction may include only supplemental resources. For example, a first entity may request to send only rewards points to a second entity. Rewards points cannot be transferred over traditional payment rails. When using traditional processing rails the rewards points are first transferred into resources (e.g., electronic funds) and transferred using traditional processing rails. This process uses more computing capacity, memory, and increases the time of the interactions. Alternatively, supplemental resources (e.g., rewards points) can be transferred using the real-time resource exchange network 200. For example, in some embodiments of the invention the messaging fields of a real-time interaction communication may be utilized to outline the type of supplemental resources, the amount of supplemental resources, and/or any conversion of the supplemental resources into a different type or amount for the interaction.

FIG. 3 illustrates in block 310 that depending on the resource pool to which the supplemental resources may be transferred the supplemental resources may or may not be converted (e.g., into other supplemental resource types and/or amounts, and/or into electronic funds). In some embodiments of the invention the supplemental resource convertor module 218 is accessed in order to determine how to convert the supplemental resources of the first entity to the second entity based on stored conversions for each resource pool for each entity and/or organization. For example, while rewards points may be transferred directly between reward accounts using the real-time resource exchange network 200, the rewards points may be required to be converted (e.g., scaled, or the like). For example, “X” rewards points from the first entity may not transfer into “X” reward points for the second entity. As such, a converter (e.g., multiplier, divider, algorithm, or the like) may be utilized based on a determination of the conversion for sending supplemental resources from the first entity resource pool to the second entity resource pool. In other embodiments, the second entity resource pool may not be able to accept supplemental resources (e.g., rewards points), as such, in some embodiments the rewards points may be converted into resources (e.g., funds) in order to be transferred to the second entity resource pool for the interaction.

Block 312 of FIG. 3 illustrates that the supplemental resources are transferred directly from the first user resource pool to the second user resource pool. In some embodiments, the supplemental resources may be transferred directly from a first resource pool to a second resources pool through the resource exchange platform 210. In some embodiments the first organization resource pool 212 is a supplemental resource pool (e.g., a first organization rewards account) and the second organization resource pool is also a supplemental resource pool (e.g., a second organization rewards account), and the rewards can be debited and credit in the respective supplemental resource pools. In some embodiments the supplemental resources may be transferred directly between a first organization resource pool 212 of a first organization to a second organization resource pool 214 of the second organization of the organizations (e.g., a first organization 202, a second organization 206, or the like) and accounted for within the real-time interaction platform 210. That is, the first organization resource pool 212 and the second organization resource pool 214 may include pooled supplemental resources of multiple entities from each organization (e.g., multiple customers of each organization) and the supplemental resources for each entity may be accounted for virtually. As such, the supplemental resources may be held by each organization within the resource exchange platform 210 (e.g., and accounted for virtually by the first and/or second organizations) or the supplemental resources may be transferred through the resource exchange platform 210 and accounted for by each individual organization outside of the resource exchange platform 210.

FIG. 3 illustrates in block 316 that the interaction is settled between the various resource pools depending on if the interaction included supplemental resources, or portions of resources and supplemental resources. For example, the supplemental resource pools of the entities and organizations may be debited and credited accordingly, and should any resources be transferred in the interaction, resource pools may be debited and credited.

Block 318 of FIG. 3 further illustrates that the interaction, the resource exchange of the supplemental resources and/or the resources, the electronic instructions for the interaction (e.g., the entity making the request, or the like), and/or other interaction information (e.g., day and time, amounts, conversions of the supplemental resources), and/or the like may be stored. The interaction information may be stored in a log for record keeping and/or reporting purposes, such as in the interaction storage and reporting module 222 within the resource exchange platform 210.

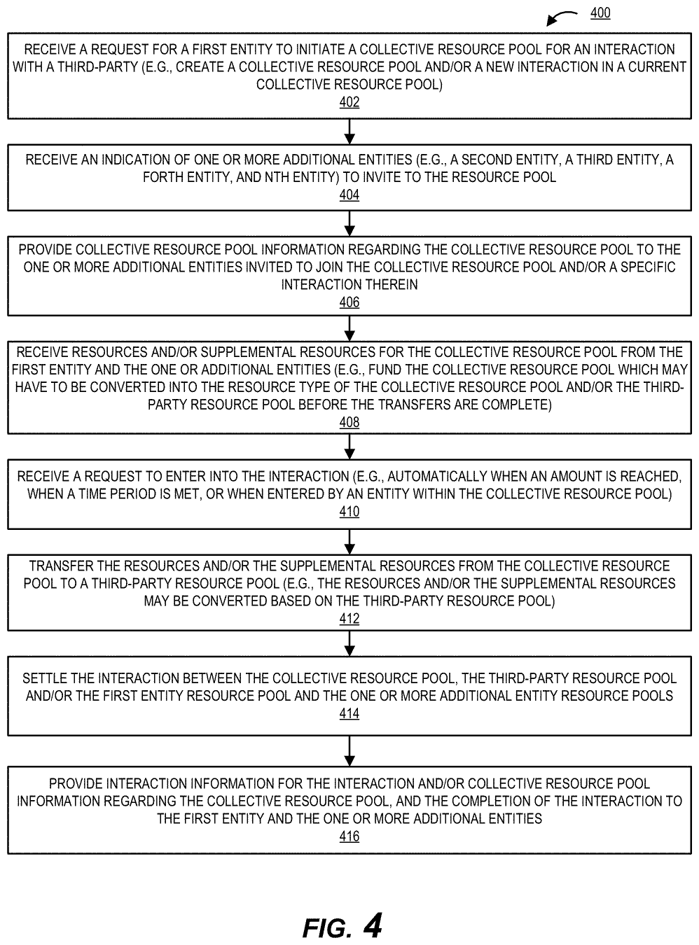

FIG. 4 provides a process flow for processing the exchange of supplemental resources into a collective resource pool for use in real-time resource exchanges, in accordance with some embodiments of the present disclosure. Block 402 of FIG. 4 illustrates that a request is received from a first entity to utilize a collective resource pool (e.g., a collective supplemental resource pool) for an interaction with a third party. The collective resource pool may be created on a one-time basis or multiple proposed interactions may be initiated with a collective resource pool (e.g., with or without different entities for each interaction within the collective resource pool). In some embodiments, the request may include interaction information, such as the identity of the third-party entity and the interaction (e.g., product, or the like) for which the resources and/or supplemental resources are intended to be utilized. For example, the interaction may be a charitable donation and the third-party entity may be the charity to which the resources will be sent. Moreover, the interaction information may further include a target resource amount or a target supplemental resource amount for the interaction (e.g., rewards goal for funding the supplemental resources or the interaction within the collective resource pool). Additionally, the interaction information may also include a target interaction time period (e.g., day, time, range of times, or the like) for entering into the interaction (e.g., occurs when the target time period is met). The interaction information may be a place-holder for a proposed interaction, a proposed third-party entity, a proposed target amount, a proposed time period, or the like that will be finalized in the future, or the interaction information (or a portion thereof) may be set at the outset and automatically occur in the future when the target resource amount and/or target supplemental resource amount is met or the target interaction time period is met (e.g., the interaction may occur in a week). As such, in some embodiments the interaction information (e.g., interaction for the product, the third-party, the target resource amount or the target supplemental resource amount, the target interaction time period, or the like) may be changed in the future, while in other embodiments the interaction information cannot be changed in the future.

FIG. 4 further illustrates in block 404 that an indication is received for one or more additional entities (e.g., a second entity, third entity, forth entity, and/or Nth entity) to access the collective resource pool. In some embodiments, the first entity invites other entities to join the collective resource pool. Additionally, the one or more additional entities that have been invited to the collective resource pool may invite the one or more other additional entities to the collective resource pool. In some embodiments the one or more additional entities may search for the interaction (e.g., donation to a particular charity) and join or request to join the collective resource pool. The invitation to join the collective resource pool may be made through the resource exchange platform 210 (e.g., through the messaging feature of the real-time resource exchange platform, or the like). As such, notifications may be provided to the entities to join the collective resource pool and transfer resources and/or supplemental resources to the resource pools.

Block 406 of FIG. 4 illustrates that collective resource pool information is provided to the one or more additional entities. That is, the interaction (or multiple interactions) and the related third-party entity for which the resources and/or supplemental resources of the collective resource pool are to be used may be provided to the one or more additional entities when the request is sent, or after the additional entities join the collective resource pool. Moreover, the entities with access to the collective resource pool may be able to access the collective resource pool to view resources and/or supplemental resources in the collective pool for an interaction, what each entity with access to the collective resource pool has transferred to the collective resource pool (e.g., if each entity opts-in with approval, or the like), and/or to confirm that the interaction with the third-party has occurred (e.g., the resources and/or supplemental resources were used for the intended purpose).

FIG. 4 further illustrates in block 408 that resources and/or supplemental resources for the collective resource pool from the first entity and the one or more additional entities is received in the collective resource pool. In some embodiments, the collective resource pool may be funded by only the supplemental resources (e.g., rewards points, or the like), only by resources (e.g., electronic funds, or the like), or a combination of supplemental resources and resources. Consequently, as previously discussed with respect to block 310 of FIG. 3, the supplemental resource converter module 218 may be utilized in order to convert different resources and/or supplemental resources (e.g., types and amounts) into the type of resources and/or supplemental resources (e.g., funds, rewards points, or the like) of the collective resource pool. For example, a first entity may provide resources (e.g., electronic funds), another entity may provide first rewards points (e.g., worth one cent per point), a third entity may want to contribute second rewards points (e.g., worth two cents per point), a fourth entity may want to provide airline miles, or the like. These different types of resources and/or supplemental resources may be converted to a resource type of the collective resource pool (e.g., funds, reward points worth an equivalent value, airline miles, or the like).

Block 410 illustrates that a request is received to enter into the interaction using the collective resource pool. In some embodiments, the interaction may be set up when creating the collective resource pool, as previously described with respect to block 402, such as through the use of a triggering event (e.g., resource amount is met, a time period is met, or the like). As such, when the trigger is met (e.g., when the time period and/or the amount of the resources for the interaction is met), the interaction may be entered into automatically by the real-time resource exchange platform 210. For example, when a goal is reached for funding the interaction or the interaction date is met, the funds may be sent to the charity. Alternatively, the first entity, another entity, or a group of entities (e.g., all of the entities approve, a percentage of the entities approve, or the like) may enter the interaction with the third-party entity at any time (e.g., after the one or more entities give approval to enter into the interaction).

FIG. 4 illustrates in block 412 the resources are transferred from the collective resource pool to a third-party resource pool when the interaction is automatically entered or approved by the one or more entities. The resources and/or supplemental resources in the collective resource pool may be transferred as previously described with respect to block 310 of FIG. 3. For example, the resources and/or supplemental resources may be converted to correspond to the resources and/or supplemental resources held in the third-party resource pool. That is, should the collective resource pool be funded with supplemental resources, the supplemental resources may be transferred directly to the third-party resource pool, may be converted with a factor based on the supplemental resources in the third-party resource pool, and/or may be converted into resources (e.g., electronic funds). In alternate embodiments, a combination of resources and supplemental resources may be transferred to the third-party resource pool.

Block 414 of FIG. 4 further illustrates that the interaction is settled between the collective resource pool, the third-party resource pool, and/or the first entity resource pool and the one or more additional entity resource pools. The interaction may be settled as previously described with respect to block 316 of FIG. 3. In some embodiments, the settlement may further include settling the resources and/or supplemental resources from the entities that funded the collective resource pool. That is, the resources and/or supplemental resources may be held in the resources pools of each user until the interaction is entered. Alternatively, should the resources and/or supplemental resources have already been transferred to the collective resource pool, the interaction and third-party with which the resources and/or supplemental resources were used by the collective resource pool may be updated in the individual resource pools of the entities that funded the collective resource pool. For example, the interaction to transfer resources to the collective resource pool for each individual entity may be updated to reflect the ultimate use of the resources and/or supplemental resources. That is, confirmation that the funds and/or rewards ultimately were transferred to the charity and the amount transferred to the charity by each individual user may be captured and stored in each of the entities' individual resource pools (e.g., for accounting, tax, budgeting, or other like purposes). Consequently, the settlement of the first entity resource pool and/or the one or more additional entity resource pools may be settled at the time each entity provides resources and/or supplemental resources to the collective resource pool (e.g., if the interaction information cannot be changed); at the time the interaction information is finalized within the collective resource pool (e.g., it could occur before the interaction is entered); or at the time the interaction is entered.

FIG. 416 of FIG. 4 further illustrates that final interaction information for the interaction made using the collective resource pool may be provided to the first entity and the one or more additional entities. That is, the final amount of the resource and/or supplemental resources used in the interaction, the verification of the completion of the interaction, the final resources and/or supplemental resources contributed by each entity to the collective resource pool, or the like may be displayed and/or sent to each of the contributing entities. The collective resource pool, including the indication of the interaction (e.g., what product, or the like), the third-party entity (e.g., merchant, charity, other user, or the like), the contribution of each of the entities, or the like provides transparency to the interaction for each of the entities that provided resources and/or supplemental resources to the collective resource pool. The collective resource pool provides transparency over traditional ways to provide pooled resources, and/or increases the flexibility how such collective resource pools may be funded using both resources (e.g., funds) and/or different types of supplemental resources (e.g., rewards points, airline miles, travel rewards, or the like).

Regardless of how the resources and/or supplemental resources are being used and transferred, as described herein, in some embodiments of the invention, it should be understood that additional security measures may be put in place in order to verify the parties involved in the interaction before the resources and/or supplemental resources are made. It should be understood that since the real-time resource exchange results in immediate transfer of resources between the entities that cannot be canceled, additional security measures may be put in place to reduce unauthorized interactions and/or resource exchanges. For example, additional verification may be required before the resource exchange is made when a new payee is being identified, a threshold resource amount is reached for the interaction (e.g., over $500, $1000, $2000, $5000, or the like of resources and/or supplemental resources), multiple interactions are entered into with the same entity, multiple interactions are made with entities located in particular regions, or the like occurs. For example, the additional verification may include two-factor authentication, security questions, passwords, verification from different user devices, or the like in order to provide a higher level of confidence that the interaction is not a misappropriated interaction.

It should be understood that the resource exchange messages (e.g., the ISO messages, or the like) used for real-time interactions are much more robust than typical automated clearing houses (AHC) and wire communications for typical interactions. The resource exchange messages allow for more information and different types of information to be included in the resource exchanges. The resource exchange messages are also much faster (e.g., within seconds) and much more secure (e.g., no physical instruments are used). In some embodiments of the invention no account numbers need to be used, and instead the one or more identifiers are all that is required to exchange resources.

As will be appreciated by one of ordinary skill in the art, the present invention may be embodied as an apparatus (including, for example, a system, a machine, a device, a computer program product, and/or the like), as a method (including, for example, a process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with real-time payment clearing and settlement.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for real-time payment clearing and settlement, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for resource exchanges over a real-time exchange network, the system comprising:
one or more memory devices with computer-readable program code stored thereon; and
one or more processing devices operatively coupled to the one or more memory devices, wherein the one or more processing devices are configured to execute the computer-readable program code to:
receive a request from a first entity to utilize a collective resource pool;
receive supplemental resources for the collective resource pool from a first entity resource pool of the first entity and one or more additional entity resource pools from one or more additional entities;
receive a request to enter into an interaction with a third-party entity;
transfer the supplemental resources from the collective resource pool to a third-party resource pool; and
provide interaction information regarding completion of the interaction with the third-party to the first entity and the one or more additional entities.

2. The system of claim 1, wherein the one or more processing devices are configured to execute the computer-readable program code to:
create the collective resource pool for the interaction with the third-party; and
provide collective resource pool information to the first entity and the one or more additional entities.

3. The system of claim 1, wherein receiving the request from the first entity to utilize the collective resource pool comprises utilizing a previously created resource pool and creating a new interaction within the collective resource pool for the interaction with the third-party.

4. The system of claim 1, wherein the one or more processing devices are further configured to execute the computer-readable program code to:
receive an indication from the first entity to invite the one or more additional entities to provide the supplemental resources to the collective resource pool.

5. The system of claim 1, wherein the one or more processing devices are further configured to execute the computer-readable program code to:
provide an indicator of the collective resource pool, the interaction, and the third-party to the one or more additional entities.

6. The system of claim 1, wherein the one or more processing devices are further configured to execute the computer-readable program code to:
settle the interaction between the collective resource pool, the third-party resource pool, and the first entity resource pool and the one or more additional entity resource pools.

7. The system of claim 1, wherein the request to enter into the interaction is made by the first entity through a first entity computer system.

8. The system of claim 1, wherein receiving the request from the first entity to utilize the collective resource pool further comprises receiving a proposed interaction with the third-party for the collective resource pool.

9. The system of claim 1, wherein the supplemental resources are converted into resources before being transferred from the collective resource pool to the third-party resource pool.

10. The system of claim 9, wherein the supplemental resources are converted from the resources back to the supplemental resources within the third-party resource pool.

11. The system of claim 1, wherein the supplemental resources are transferred directly between the collective resource pool and the third-party resource pool without being converted to resources.

12. The system of claim 1, wherein an original amount of the supplemental resources are transformed to an updated amount of the supplemental resources during the transfer.

13. The system of claim 1, wherein the supplemental resources are transformed from an original supplemental resource type to an updated supplemental resource type during the transfer.

14. The system of claim 1, wherein the supplemental resources received from the first entity or the one or more additional entities are transformed from an original supplemental resource type or an original amount to an updated supplemental resource type or an updated amount before transferred to the collective resource pool.

15. The system of claim 1, wherein the supplemental resources are transferred from the collective resource pool to the third-party resource pool when the supplemental resources within the collective resource pool reach a trigger amount.

16. The system of claim 1, wherein the supplemental resources are transferred from the collective resource pool to the third-party resource pool when a trigger time period is met.

17. The system of claim 1, wherein the transfer of the supplemental resources occurs through the real-time exchange network directly between the collective resource pool and the third-party resource pool without using traditional processing rails.

18. The system of claim 1, wherein the one or more processing devices are configured to execute the computer-readable program code to:
provide a notification to the one or more additional entities when an entity transfers the supplemental resources to the collective resource pool, wherein the notification comprises at least the entity an amount of the supplemental resources.

19. A computer-implemented method for resource exchange over a real-time exchange network, the computer-implemented method comprising:
receiving, by one or more processors, a request from a first entity to utilize a collective resource pool;
receiving, by the one or more processors, supplemental resources for the collective resource pool from a first entity resource pool of the first entity and one or more additional entity resource pools from one or more additional entities;
receiving, by the one or more processors, a request to enter into an interaction with a third-party entity;
transferring, by the one or more processors, the supplemental resources from the collective resource pool to a third-party resource pool; and
providing, by the one or more processors, interaction information regarding completion of the interaction with the third-party to the first entity and the one or more additional entities.

20. A computer program product for resource exchange over a real-time exchange network, the computer program product comprising at least one non-transitory computer-readable medium having computer-readable program code portions embodied therein, the computer-readable program code portions comprising:
an executable portion configured to receive a request from a first entity to utilize a collective resource pool;
an executable portion configured to receive supplemental resources for the collective resource pool from a first entity resource pool of the first entity and one or more additional entity resource pools from one or more additional entities;
an executable portion configured to receive a request to enter into an interaction with a third-party entity;
an executable portion configured to transfer the supplemental resources from the collective resource pool to a third-party resource pool; and
an executable portion configured to provide interaction information regarding completion of the interaction with the third-party to the first entity and the one or more additional entities.
